(19) United States
(12) Patent Application Publication
(10) Pub. No.: US 2006/0006213 A1
(43) Pub. Date: Jan. 12, 2006

(54) Method of supplying paste solder material and metal mask therefor

(75) Inventors: Akira Kamisaka, Hadano (JP); Kaoru Katayama, Hadano (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/176,835

(22) Filed: Jul. 6, 2005

(30) Foreign Application Priority Data
Jul. 9, 2004 (JP) 2004-202568

(51) Int. Cl. B23K 31/00

(52) U.S. Cl. 228/248.1

(57) ABSTRACT

When different paste solder materials are printed to circuit patterns on a substrate, a plurality of metal masks corresponding to kinds of solder materials are used so as to perform printing in a manner corresponding to each of the solder materials, so that the particular solder materials are supplied to particular components in the same flat surface. One of the metal mask is provided with a depression so that the mask does not contact the solder material which has already been printed, and the metal mask is further provided with another depression to reduce an amount of the solder material supplied.

### INCORPORATION BY REFERENCE

The present application claims priority from Japanese application JP2004-202568 filed on Jul. 9, 2004, the content of which is hereby incorporated by reference into this application.

### BACKGROUND OF THE INVENTION

1. Field of the Invention

The present invention relates to a method of supplying a paste solder material when the paste solder material is used to solder a component to a circuit pattern during printed board assembly, and also relates to a metal mask therefor.

2. Description of the Related Art

In assembly of a printed board, it is a commonly used technique at present to connect a paste solder material using a printing process. While high density packaging and hybridization of substrates are currently advancing, due to a mounting structure of a component and to heat resisting properties thereof and further to high percent defective thereof, in consideration of replacement of a component after finding defective in an inspection or the like, different solder materials corresponding to particular kinds of components need to be used to connect the components onto the same flat surface in an assembly process of the substrate. In connection with this, JP-A-5-212852 and JP-A-2002-144526 are referred to.

### BRIEF SUMMARY OF THE INVENTION

In order to print different solder materials onto the same flat surface using metal masks, a plurality of processes are required, and an optimum amount of solder material must be supplied for each process.

It is an object of the present invention to provide a method of highly accurately supplying a plurality of different paste solder materials, and to provide the metal mask therefor.

To attain the above object, in a method of supplying the paste solder material according to the present invention, optimum amounts of different solder materials corresponding to kinds of components are supplied onto the same surface by use of the metal mask to perform printing. Further, the metal mask is provided with a depression on its substrate-side surface so that the mask does not contact the solder material which has already been printed on a circuit pattern, and the metal mask is further provided with a depression on its surface opposite to the substrate-side surface to control the amount of paste solder material.

Other objects, features and advantages of the invention will become apparent from the following description of the embodiments of the invention taken in conjunction with the accompanying drawings.

### BRIEF DESCRIPTION OF THE DRAWINGS

FIG. 1A to FIG. 1I are diagrams showing an example of a sequence of a solder supplying method in one embodiment according to the present invention.

### DETAILED DESCRIPTION OF THE INVENTION

A preferred embodiment according to the present invention will hereinafter be described in detail with reference to the drawings. It is to be noted that the present invention is not limited thereto.

In a best mode to implement the present invention, printing is started, in respect of an order of printing and supplying solder materials, from the solder material which is supplied in a smallest range among the solder materials supplied, irrespective of melting points of the solder materials used, and then, the printing is carried on in order of size of the supplied solder material range from a smaller one to a larger one, and the last printing is conducted by the solder material supplied in the largest printing range among the solder materials supplied.

Furthermore, with regard to connection between components and a substrate, the component which is most frequently replaced is desirably connected by the solder material whose melting point is the lowest among the solder materials used, in view of percent defective and difficulty in replacement of components, as long as strength and reliability are sufficiently secured in soldering among the components, the solder materials and the substrate.

In setting a temperature during soldering, if preheating is required for the substrate, the components and the solder materials, a preheating temperature is desirably set to a temperature lower than a melting point of the solder material which is the lowest among those of a plurality of solder materials used, that is, a temperature at which these solder materials do not melt.

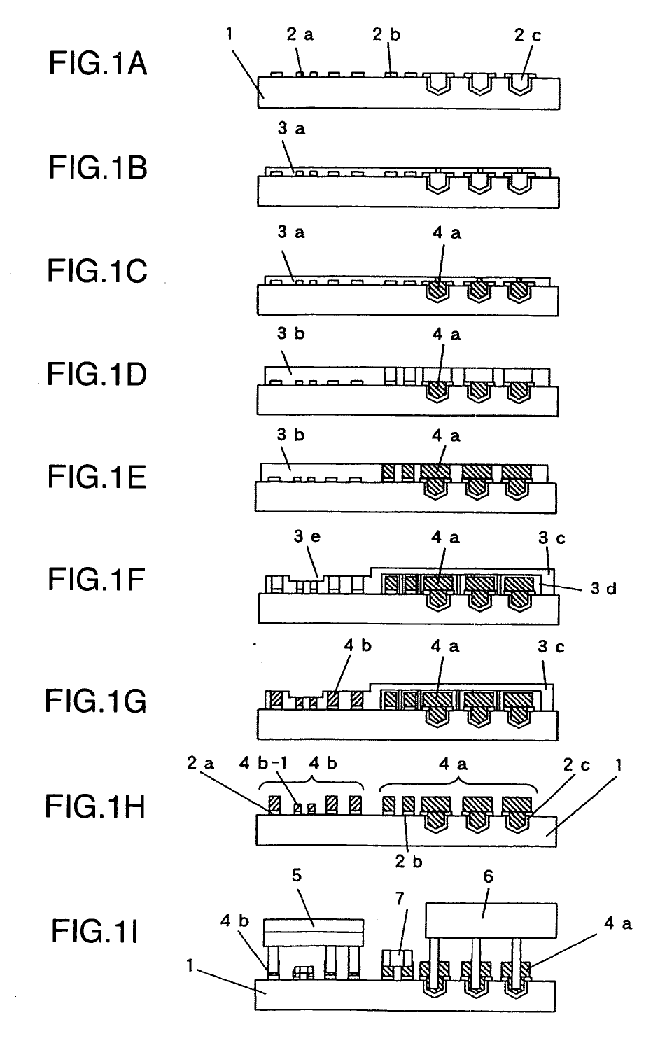

One embodiment will be described referring to FIG. 1A to FIG. 1I in which a solder supplying method according to the present invention is implemented using a printing process. In FIG. 1A, 1 denotes a substrate, and 2a, 2b denote circuit patterns on a substrate surface which need to be supplied with the solder materials. This substrate 1 is provided with a recess in which a pattern 2c is formed. This may be dispensed with depending on how the substrate to be assembled is embodied.

First, as shown in FIG. 1B and FIG. 1C, a first solder material 4a is printed on the substrate 1 using a metal mask 3a. In this case, since it is necessary to embed the solder material in a recess pattern 2c, the metal mask 3a is only provided with an opening at a portion corresponding to this recess pattern 2c, and the metal mask 3a used is thin and its opening has a small diameter. Under these circumstances, printing is automatically implemented by using an automatic printing machine. The automatic printing machine is used in all the subsequent printing.

Next, as shown in FIG. 1D and FIG. 1E, a metal mask 3b is used to further print the solder material 4a on a surface of the recess pattern 2c. By using the metal mask 3b at this instance, the solder material is also supplied to the other patterns 2b which need to be connected by this first solder material 4a as well as the recess pattern 2c. The supply of the first solder material 4a is thus completed.

Subsequently, as shown in FIG. 1F, FIG. 1G and FIG. 1H, a second solder material 4b is printed using a second solder metal mask 3c. At this point, to avoid a part where the first solder material 4a has already been printed, the metal mask 3c is provided with, on its substrate contact surface, a clearance (depression) 3d avoiding the first solder material 4a already printed. Further, to adjust a thickness of a paste for the second solder material 4b, a depression 3e is provided which partially reduces a thickness of the metal mask 3c. This second solder metal mask 3c is manufactured by an electroforming method so that the clearance for the first solder material 4a is easily formed and that a printing quality will be stable.

Thus, the first solder material 4a and the second solder material 4b are supplied onto the flat surface of the same substrate by use of the printing process, so that the particular solder materials can be stably supplied to particular connecting portions, while a portion 4b-1 can also be produced where an amount of solder is partially reduced.

Then, as shown in FIG. 1I, components 5, 6, 7 are installed on the substrate, and soldering is carried out. In the present embodiment, a reflow process is used to perform soldering. In setting a temperature during this process, an upper limit value of a preheating temperature of the substrate is kept lower than a melting point of the solder material which is the lowest among those of the solder materials used, which prevents all the solder materials from melting during preheating, and flux contained in all the solder materials is adjusted so that it will be most active during the preheating.

Two kinds of solder materials are used for the components in the present embodiment, but the present invention is compatible with two or more kinds of solder materials. The solder material whose melting point is low, that is, the second solder material 4b is used for the component 5 which is frequently replaced, while the solder material whose melting point is high, that is, the first solder material 4a is used to connect the component 6 which is less frequently replaced. The solder materials are suitably used as described above, so that during replacement of the component 5 which is frequently replaced, it is possible to reduce a thermal effect to peripheral connecting portions of the components 6, 7 and the like which are less frequently replaced.

It should be further understood by those skilled in the art that although the foregoing description has been made on embodiments of the invention, the invention is not limited thereto and various changes and modifications may be made without departing from the spirit of the invention and the scope of the appended claims.

1. A method of supplying a paste solder material to solder a component to a circuit pattern on a substrate, comprising:
supplying, onto the same surface, optimum amounts of different solder materials corresponding to kinds of components by use of a metal mask to perform printing.

2. The method of supplying the paste solder material according to claim 1, further comprising:
start printing from a solder material which is supplied in a smallest range among said different solder materials.

3. The method of supplying the paste solder material according to claim 1, further comprising:
printing, onto the circuit pattern to which a particular kind of component is connected, a solder material whose melting point is lower than that of a solder material supplied to a kind of component which is replaced less frequently than said particular kind of component.

4. The method of supplying the paste solder material according to claim 2, further comprising:
printing, onto the circuit pattern to which a particular kind of component is connected, a solder material whose melting point is lower than that of a solder material supplied to a kind of component which is replaced less frequently than said particular kind of component.

5. The method of supplying the paste solder material according to claim 1, further comprising:
printing, onto the circuit pattern to which a particular kind of component is connected, a solder material whose melting point is higher than that of a solder material supplied to a kind of component which is replaced more frequently than said particular kind of component.

6. The method of supplying the paste solder material according to claim 2, further comprising:
printing, onto the circuit pattern to which a particular kind of component is connected, a solder material whose melting point is higher than that of a solder material supplied to a kind of component which is replaced more frequently than said particular kind of component.

7. The method of supplying the paste solder material according to claim 1, further comprising:
setting an upper limit value of a preheating temperature of said substrate when the component is soldered to said substrate to a value lower than a melting point of a solder material which is the lowest among those of said solder materials.

8. The method of supplying the paste solder material according to claim 1, further comprising:
setting an upper limit value of a preheating temperature of the component when the component is soldered to said substrate to a value lower than a melting point of a solder material which is the lowest among those of said solder materials.

9. The method of supplying the paste solder material according to claim 1, further comprising:
setting an upper limit value of a preheating temperature of said solder material when the component is soldered to said substrate to a value lower than a melting point of a solder material which is the lowest among those of said solder materials.

10. A metal mask to print a paste solder material by which a component is soldered to a circuit pattern on a substrate, wherein a depression is provided on a substrate-side surface of said mask so that the mask does not contact said solder material which has already been printed on the circuit pattern, and another depression is further provided on a surface of the mask opposite to the substrate-side surface to control an amount of the paste solder material.

11. A metal mask to print a paste solder material by which a component is soldered to a circuit pattern on a substrate, wherein a depression is provided on a substrate-side surface of said mask so that the mask does not contact said solder material which has already been printed on the circuit pattern, and another depression is further provided on a surface of the mask opposite to the substrate-side surface to adjust a thickness of the paste solder material.

12. The metal mask according to claim 10, wherein the metal mask is manufactured by an electroforming method.
